(19) United States
(12) Patent Application Publication
(10) Pub. No.: US 2022/0062901 A1
(43) Pub. Date: Mar. 3, 2022

(54) ELECTRODE PAIRS ON EITHER SIDE OF MICROFLUIDIC CHANNELS

(71) Applicant: HEWLETT-PACKARD DEVELOPMENT COMPANY, L.P., Spring, TX (US)

(72) Inventors: Brian J. Keefe, San Diego, CA (US); Alexander Govyadinov, Corvallis, OR (US); Jae Elliot De Leon, San Luis Obispo, CA (US); Braden Thomas Andrews, San Luis Obispo, CA (US); David S. Clague, San Luis Obispo, CA (US)

(73) Assignee: HEWLETT-PACKARD DEVELOPMENT COMPANY, L.P., Spring, TX (US)

(21) Appl. No.: 17/459,997

(22) Filed: Aug. 27, 2021

Related U.S. Application Data
(63) Continuation-in-part of application No. PCT/US2020/048470, filed on Aug. 28, 2020.

(51) Int. Cl. B01L 3/00

(52) U.S. Cl. CPC B01L 3/502715; B01L 2400/0415; B01L 2300/0645; B01L 3/502761

(57) ABSTRACT

In one example in accordance with the present disclosure, a fluid manipulation system is described. The fluid manipulation system includes a microfluidic channel through which fluid is to flow. The fluid includes particles to be separated. The fluid manipulation system includes a first electrode pair on a first side of the microfluidic channel. The first electrode pair includes a top electrode formed on a lid of the microfluidic channel and a bottom electrode formed on a floor of the microfluidic channel. The fluid manipulation system also includes a second electrode pair on a second side of the microfluidic channel. The second electrode pair also includes a top electrode and a bottom electrode. The electrode pairs are to generate an alternating electrical field across the microfluidic channel.

### BACKGROUND

Analytic chemistry is a field of chemistry that uses instruments to separate, identify, and quantify matter. In one particular example, cells, organelles, and molecules within a sample can be extracted and analyzed. A wealth of information can be gleaned from the extracted cells, organelles, and particles.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a front view of a fluid manipulation system with electrode pairs on either side of a microfluidic channel, according to an example of the principles described herein.

FIG. 2 is an isometric view of a fluid manipulation system with electrode pairs on either side of a microfluidic channel, according to an example of the principles described herein.

FIGS. 3A and 3B are views of a fluid manipulation system with electrode pairs on either side of a microfluidic channel, according to an example of the principles described herein.

FIG. 4 is a view of a through hole on either side of a microfluidic channel, according to an example of the principles described herein.

FIG. 5 is a flowchart of a method for forming a fluid manipulation system with electrode pairs on either side of a microfluidic channel, according to an example of the principles described herein.

FIG. 6 is an isometric view of a fluid manipulation system with electrode pairs on either side of a microfluidic channel, according to an example of the principles described herein.

FIG. 7 is a flowchart of a method for forming a fluid manipulation system with electrode pairs on either side of a microfluidic channel, according to an example of the principles described herein.

FIG. 8 is a top view of a fluid manipulation system with electrode pairs on either side of a microfluidic channel, according to an example of the principles described herein.

FIG. 9 is a diagram of a fluid manipulation system with electrode pairs on either side of a microfluidic channel, according to examples of the principles described herein.

FIG. 10 is a diagram of a fluid manipulation system with electrode pairs on either side of a microfluidic channel, according to examples of the principles described herein.

FIG. 11 is a top view of a fluid manipulation system with electrode pairs on either side of a microfluidic channel, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Analytic chemistry involves the study and analysis of cellular components such as cells, nucleic acid, and other biomolecules contained within a fluid sample. One particular example of a biological compound that is studied and that yields a wealth of information is nucleic acid. Therefore, the study and analysis of nucleic acid may provide insight into how living things operate and may provide information to treat certain ailments. As a specific example, the study of nucleic acids may lead to the treatment of certain disorders that plague society. As another example, the capture of exogenous deoxyribonucleic acid (DNA) and ribonucleic acid (RNA) from a blood sample may be used to detect cell necrosis. In yet another example, DNA may be isolated to identify an organism or to identify damage such as single nucleotide polymorphisms. While particular examples are presented, other genes or biomolecules may be isolated for replication.

As another example, scientists may conduct a polymerase chain reaction (PCR) to generate high quantities of DNA on which studies are performed. PCR makes millions to billions of copies of a specific DNA sample. As such, a scientist may take a small sample of DNA and amplify it to a large number of copies, such that it may be studied in detail. During PCR, a sample is quickly heated to around 100 degrees Celsius (C) and then cooled to around 50 degrees C. This process is repeated tens of times.

While such particles can provide valuable information for subsequent analysis, current methods of analyzing these particles lack refinement and may inhibit the accuracy and reliability of their analysis. As used in the present specification and in the appended claims, the term “particle” may refer to any molecule, cell, bacteria, or organelle of interest. Before a particle, compound, or other chemical structure can be studied, it is first extracted from a fluid and concentrated into an amount that can be effectively studied. Accordingly, the present specification describes a system that separates the nucleic acid, or any other biomolecule to be studied, from the sample or carrier fluid in which it is disposed. The present specification, as compared to others, provides efficient extraction.

In addition to enhanced extraction, the fluidic manipulation system of the present specification also provides efficient mixing of various compounds. That is, two compounds may be mixed so as to produce a chemical reaction. In some microfluidic devices, a fluid flow through the analysis volume may have a low Reynolds number such that fluid and particles flow through without interacting with one another. This lack of reaction may negatively impact or skew any subsequent results.

Accordingly, by increasing turbulence in the flow via transverse motion of the fluid, an enhanced mixing operation is promoted such that the chemical reaction occurs as intended. As a particular example, in PCR, a PCR master mix may be combined with a biological sample. If the PCR master mix is not properly mixed with the sample, PCR may be inefficient. Accordingly, the fluid manipulation system of the present specification ensures a thorough mixing of these components and any other intended to be mixed in a reaction chamber.

Separation of particles from a fluid or mixing of particles may be complex and costly. In some examples, a fluid flow may be introduced into a channel and separating structures may be used to capture target biomolecules. However, due to a low Reynolds number that may exist in microfluidic flow, there may be limited mixing and a low rate of particle extraction as particles pass through the separating structure without being captured.

Accordingly, the present specification describes a fluid manipulation system that increases the rate of extraction and/or mixing. Specifically, the present fluid manipulation system generates a transverse electrokinetic motion in particles to increase a particle's exposure time to the extraction surfaces, thus increasing the efficiency of particle extraction. The transverse electrokinetic motion is generated by applying alternating electric fields across the microfluidic channel, which microfluidic channel may include adsorptive pillars. The applied electric field, alternating current (AC) frequency, field strength, and flow rate move the particles in a direction perpendicular to the fluid flow. The amount of movement is modulated comparable to a pillar-to-pillar distance.

The present specification also describes an electrode arrangement that increases the transverse electrokinetic motion. That is, some arrangements of electrodes may exhibit inefficiencies with regards to generating the motion of particles. For example, in some arrangements the realized field strength decreases across a width of the microfluidic channel such that there are uneven electrical fields throughout the microfluidic channel. Put another way, the electrical field may attenuate at certain locations in the microfluidic channel. This attenuation may inhibit the ability of the electrodes to generate the motion of the particles.

The arrangement of the electrodes may define the amount of electrical field variation. Vertical electrodes extending from a floor to a ceiling may be formed on the sidewalls of the microfluidic channels. These vertical electrodes may generate an enhanced electrical field; however, they are costly and complex to manufacture. The anticipated efficacy of the vertical electrodes may never materialize as the complexity and complications in the manufacturing process may preclude achieving the anticipated effect.

Accordingly, the present specification describes an electrical connection that generates an electrical field that imitates the vertical electrodes, but is not as costly or complex to manufacture. Specifically, the device includes a base substrate and a lid substrate. Each substrate has planar electrodes deposited thereon. Accordingly, on each side of the microfluidic channel there may be an electrode pair, a bottom electrode and a top electrode, separated by a gap. The gap may be filled with a conductive material to electrically connect the top and bottom electrodes. In an example, a lead is connected to both sets of planar electrodes through a port in the base substrate. Such a fluid manipulation system has been demonstrated to exhibit a more uniform field than single planar electrodes and is easier to manufacture than vertical three-dimensional electrodes. That is, the present systems and methods provide an electrical connection that facilitates an enhanced electrical field within a microfluidic channel.

Specifically, the present specification describes a fluid manipulation system that includes a microfluidic channel through which fluid is to flow. In this example, the fluid includes particles to be separated. A first electrode pair of the fluid manipulation system is on a first side of the microfluidic channel. The first electrode pair includes a top electrode formed on a lid of the microfluidic channel and a bottom electrode formed on a floor of the microfluidic channel. A second electrode pair of the fluid manipulation system is on a second side of the microfluidic channel. The second electrode pair includes a top electrode and a bottom electrode. The electrode pairs are to generate an alternating electrical field across the microfluidic channel.

In an example, the fluid manipulation system includes a through hole formed through the bottom electrode of the first electrode pair and a through hole formed through the bottom electrode of the second electrode pair. In this example, the bottom electrode of the first electrode pair and the bottom electrode of the second electrode pair include a ring electrode around a respective through hole.

In an example, the fluid manipulation system includes a third electrode pair on a third side of the microfluidic channel, which third electrode pair includes a top electrode and a bottom electrode. In this example, the fluid manipulation system also includes a fourth electrode pair on a fourth side of the microfluidic channel. This fourth electrode pair also includes a top electrode and a bottom electrode. In an example, the first side and the second side are parallel to the flow of the fluid through the microfluidic channel while the third side and the fourth side are perpendicular to the flow of the fluid through the microfluidic channel.

In an example, the fluid manipulation system includes an array of particle-capturing pillars disposed within the microfluidic channel. In a particular example, regions of the microfluidic channel that include particle-capturing pillars may be separated by regions where a floor of the microfluidic channel comprises chevron recesses. In a more particular example, the particle-capturing pillars are formed in trenches in the floor of the microfluidic channel. These chevron recesses promote turbulence which increases extraction and/or mixing. That is, the chevron recesses impede laminar flow in the fluid and introduce vortices and chaotic mixing such that the particles in the fluid reside in the microfluidic channel for a longer period of time and thus have greater opportunity to interact with the particle-capturing pillars and/or other fluids in a reaction volume. Moreover, the fluid may be mixed and/or disturbed before entering an array of particle-capturing pillars. Such a mixing before entering the array promotes a more uniform distribution of the particles throughout the liquid carrier such that particles are uniformly captured across a width of the microfluidic channel.

The present specification also describes a method. According to the method, a top electrode for a first electrode pair and a top electrode for a second electrode pair are formed in a lid layer of a microfluidic channel. A recess is formed in a channel layer, which recess is to 1) define the microfluidic channel and 2) retain bottom electrodes for the first electrode pair and the second electrode pair. A bottom electrode for the first electrode pair and a bottom electrode for the second electrode pair is formed in regions of the recess that are adjacent a region of the recess which is to define the microfluidic channel. The lid layer and the channel layer are then joined to form a microfluidic channel with electrode pairs on either side with a gap between respective top and bottom electrodes.

In an example, particle-capturing pillars are formed within the microfluidic channel. A through hole may also be formed through the bottom electrode of the first electrode pair and a through hole may be formed through the bottom electrode of the second electrode pair. As described above, a conductive material may be introduced into the through holes to electrically couple the top electrode and bottom electrode of respective electrode pairs. Also as described above, a lead may be attached to the bottom electrodes of the electrode pairs via the through holes. In an example, the microfluidic channel is isolated from the electrode pairs.

In another example, the fluid manipulation system includes a microfluidic channel through which fluid is to flow. The fluid includes particles to be separated and the fluid manipulation system includes an array of particle-capturing pillars disposed within the microfluidic channel to capture particles from the fluid. The fluid manipulation system also includes a first electrode pair along a first sidewall of the microfluidic channel, which first electrode pair includes a top electrode and a bottom electrode with a gap therebetween. The fluid manipulation system also includes a second electrode pair along a second sidewall of the microfluidic channel. The second electrode pair also includes a top electrode and a bottom electrode with a gap therebetween. As described above, the electrode pairs are to generate periodic alternating electrical fields of different values across the microfluidic channel to induce wall-to-wall movement of the fluid towards the particle-capturing pillars. The fluid manipulation system also includes a controller. The controller is to determine, based on a weight and an electrical charge of particles to be captured, alternating electrical fields to move the particles a distance at least as great as a spacing between particle-capturing pillars and apply voltages to generate the alternating electrical fields.

In an example, the fluid manipulation system includes a barrier between each of the first electrode pair and the second electrode pair and the microfluidic channel.

As used in the present specification and in the appended claims, the term “biomolecule” may refer to molecules such as amino acids, sugars, nucleic acids, proteins, polysaccharides, DNA, RNA, cells, and organelles that occur naturally in living organisms. One specific example of biomolecules to be captured include deoxyribonucleic acid (DNA) and ribonucleic acid (RNA). In an example, the biomolecules to be captured may include bio-macromolecules which are large macromolecules (or polyanions) such as proteins, carbohydrates, lipids, and nucleic acids (such as DNA and RNA) as well as small molecules such as primary metabolites, secondary metabolites, and natural products. In some examples, this class of material may be referred to as biological materials. Other examples of biomolecules that may be captured include cells such as mammalian cells and non-mammalian cells.

Further, as used in the present specification and in the appended claims, the term “chevron” refers to a pointed shape. That is, a chevron recess may refer to a V-shaped recess. In the examples discussed below, the point of the chevron, or V-shaped recess, may be parallel to the direction of a flow of fluid through the channel.

In summary, using such a fluid manipulation system 1) provides efficient particle separation from a liquid carrier; 2) may reduce the size of the fluid manipulation system by capturing more particle in a smaller distance; 3) increases particle time in a particle-capturing region; 4) generates a more uniform electrical field for particle capture; 5) induces transverse flow of particles to increase mixing and probability for particle capture; 6) provides large surface area for capturing particles; 7) is a simple structure to integrate on a chip; 8) provides low fluidic resistance; and 9) is low cost. However, the devices disclosed herein may address other matters and deficiencies in a number of technical areas.

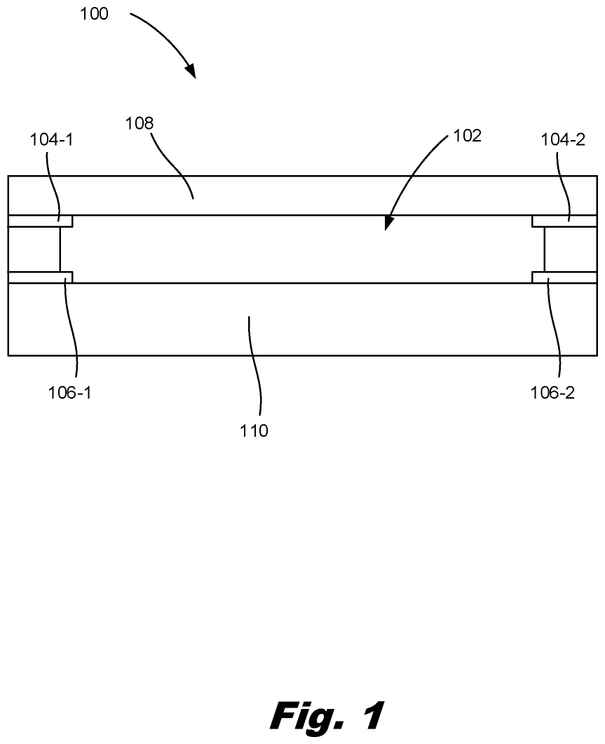

Turning now to the figures, FIG. 1 is a front view of a fluid manipulation system (100) with electrode pairs on either side of a microfluidic channel (102), according to an example of the principles described herein. The fluid manipulation system (100) is a collection of components for separating and analyzing a fluid sample. In some examples, the fluid manipulation system (100) is a microfluidic structure. In other words, the components, i.e., the microfluidic channel (102), particle-capturing pillars, and electrodes (104) may be microfluidic structures. A microfluidic structure is a structure of sufficiently small size (e.g., of nanometer sized scale, micrometer sized scale, millimeter sized scale, etc.) to facilitate conveyance of small volumes of fluid (e.g., picoliter scale, nanoliter scale, microliter scale, milliliter scale, etc.). For example, the depth of the microfluidic channel (102) may be between 5 and 500 micrometers and the width of the microfluidic channel (102) may be between 30 and 3,500 micrometers. In a specific example, a depth-to-width ratio of the microfluidic channel (102) is between 1:3 and 1:100. Note that in these examples, the dimensions of the microfluidic channel (102) may impact the voltage, frequency, and flow rate parameters. This may be due to the changes in cross-sectional area and electrode separation, distance, and shape.

In some examples, walls and a floor of the microfluidic channel (102) may be formed on a channel layer (110) and sealed at the top with a lid layer (108) to create an enclosed microfluidic channel (102). In some examples, the lid layer (108) is formed of a transparent material such that a user may view the particle-capture operation or such that an imaging device may capture the particle capture operation.

As described above, the fluid manipulation system (100) includes a microfluidic channel (102) through which fluid is to flow. The fluid may include particles that are to be separated. For example, the fluid may be a solution that includes biomolecules such as DNA or RNA. A scientist may desire to separate the DNA or RNA from the fluid such that the DNA or RNA may be studied, processed, or otherwise acted upon. As one specific example, PCR is an operation wherein millions or billions of copies of a specific DNA sample are replicated. However, prior to PCR, the DNA in a given sample may be separated and concentrated via the fluidic manipulation system (100) to enhance PCR efficacy.

In some examples, the fluid flow through the microfluidic channel (102) may be generated by a pump that is disposed upstream or downstream from the particle-capturing region of the microfluidic channel (102). In some examples, the pump may be an integrated pump, meaning the pump is integrated into a wall of the microfluidic channel (102). In some examples, the pump may be an inertial pump which refers to a pump which is in an asymmetric position within the microfluidic channel (102). In some examples, the pump may be a thermal inkjet resistor, or a piezo-drive membrane or any other displacement device.

As described above, the microfluidic channel (102) may be used for the mixing or separation of components of different samples. However, it may be the case that some particles pass through the microfluidic channel (102) without being captured. For example, given the dimension of the microfluidic channel (102), the fluid flow may have a low Reynolds number such that fluid and particles flow through the microfluidic channel (102) without interacting with one another, or past an array of particle-capturing pillars without interacting with the particle-capturing pillars. Accordingly, to ensure a sufficient capture rate, some systems implement a longer and more resistive microfluidic path to ensure adequate capture. However, the longer path results in a larger microfluidic device that may include complicated and torturous paths.

Accordingly, the current fluid manipulation system (100) includes electrode pairs on either side of the microfluidic channel (102). Specifically, a first electrode pair on a first side of the microfluidic channel includes a top electrode (104-1) formed on a lid of the microfluidic channel (102) and a bottom electrode (106-1) formed on a floor of the microfluidic channel (102). Similarly, a second electrode pair on a second side of the microfluidic channel (102) includes a top electrode (104-2) formed on a lid of the microfluidic channel (102) and a bottom electrode (106-2) formed on a floor of the microfluidic channel (102).

In some examples, the first and second sides of the microfluidic channel (102) may refer to the sidewalls of the microfluidic channel (102). As such, each sidewall includes an electrode pair that is formed of a top electrode (104) and a bottom electrode (106) that are separated by a gap as depicted in FIG. 1. As demonstrated below, this arrangement may be simple to manufacture as it does not include the formation of a vertical electrode. However, the performance of such a top/bottom electrode per sidewall may approach that of a vertical electrode.

As described above, the electrode pairs are to generate an alternating electrical field across the microfluidic channel (102). That is, an alternating current is passed to the electrodes (104, 106) such that an alternating electrical field is generated across the microfluidic channel (102). As each particle within a fluid sample has an electrical charge, the applied electrical field may interact with the particle, (e.g., DNA and ions, in solution) to move it. Depending on the polarity of the electrical field, particles will move perpendicular to the flow of fluid in an oscillatory fashion depending on the field frequency. This transverse flow promotes collisions or interactions of the particles with one another or with particle-capturing pillars such that they may be captured and subsequently extracted for further analysis.

Such motion may be referred to as electrokinetic motion and may include a variety of components. That is, the current fluid manipulation system (100) moves particles within a fluid due to the influence of an alternating electrical field. The fluid itself, entrained by field-induced ion motion also moves due to the influence of an alternating electrical field. This type of motion may be referred to as electroosmotic flow. If the electrical field is generated in a direction perpendicular to the flow of fluid through the microfluidic channel (102), the particles and the fluid are influenced to move transverse to the flow of fluid through the microfluidic channel (102). In an example where the microfluidic channel (102) includes particle-capturing pillars, the particles are pushed and pulled into the particle-capturing pillars, thus enhancing the interactions between particles and the particle-capturing pillars and increasing the overall rate of particle capture.

Without the electrokinetic effects induced by an alternating electric field, a capture rate may be between around 25-30%. However, a test indicated that with electrodes set to a 15-volt, 10 hertz alternating current (AC) sinusoidal voltage, a capture rate rose to around 90%. The increased capture rate may reduce the size of the fluid manipulation system (100) as less space and lower fluidic resistance are used to capture the same concentration of particles. Moreover, it may be that a greater percentage of particles in a sample are captured, which may lead to less uncaptured particles, and therefore less waste. Still further, as a greater electrical field is generated by the more efficient electrode pairs separated by a gap, the same electroosmotic and electrokinetic flow may be generated with reduced voltage and reduced power as the electrical field is more efficient. Accordingly, the power consumption of the fluid manipulation system (100) may be reduced to achieve a target electrical field strength.

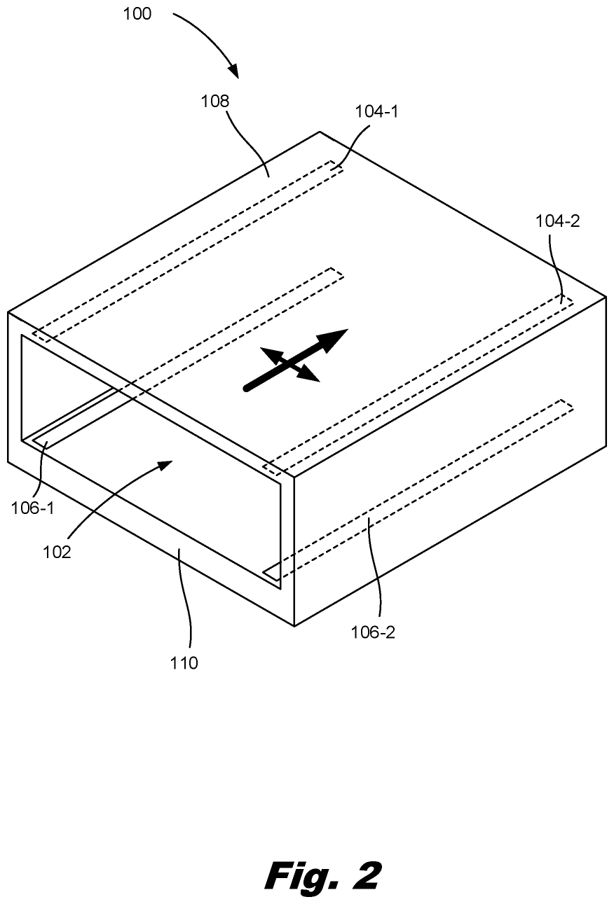

FIG. 2 is an isometric view of a fluid manipulation system (100) with electrode pairs on either side of a microfluidic channel (102), according to an example of the principles described herein. FIG. 2 clearly depicts the electrodes (104-1, 104-2, 106-1, 106-2) that make up each electrode pair. In the example depicted in FIG. 2, due to the operation of a pump or other flow-inducing mechanism, flow through the microfluidic channel (102) may be in a direction indicated by the large arrow. However, due to the microfluidic flow dynamics, portions of the fluid and the particles, may flow through the microfluidic channel (102) without interacting with one another and may flow past any particle-capturing pillars without interacting with them. As described above, an alternating voltage may be applied between the electrode pairs such that charged particles are driven in a zig-zag pattern in a direction indicated by the smaller double arrow depicted in FIG. 2. This zig-zag pattern of the particles reduces their ability to flow by any particle-capturing pillars without interacting with them. That is, the alternating electrical fields promote interactions between the particles and between the particles and any particle-capturing pillars.

The electrodes may be activated to generate an alternating electrical field across the microfluidic channel (102). In an example where the microfluidic channel (102) includes particle-capturing pillars, such an action may induce wall-to-wall movement of the fluid past particle-capturing pillars thus providing greater opportunity for the particle-capturing pillars to capture particles.

In an example, particles within the fluid are then captured via adsorption onto particle-capturing pillars that may be disposed within the microfluidic channel (102). The particle-capturing pillars may have a functionalized surface to target a specific particle or to target a particular class of particle. For example, the particle-capturing pillars may include a reverse primer of a nucleic acid to capture the target nucleic acid. In another example, the particle-capturing pillars may include a non-specific coating, such as one that attracts, retains, and/or captures particles or other compounds of interest. In one particular example, the coating may be antibodies that could capture proteins.

In one particular example, the particle-capturing pillars, rather than being functionalized to capture the particle, may include beads that are functionalized to capture the particle as described above. In any case, the particle-capturing pillars provide surface area and may include a surface feature, such as a coating or tethered beads, that captures and, in some cases, draws the particles to them. Accordingly, a particle-capturing pillar may be designated so as to capture a particular target particle. Once captured, the target particle may be extracted from the particle-capturing pillars and the intended analysis carried out on the particles.

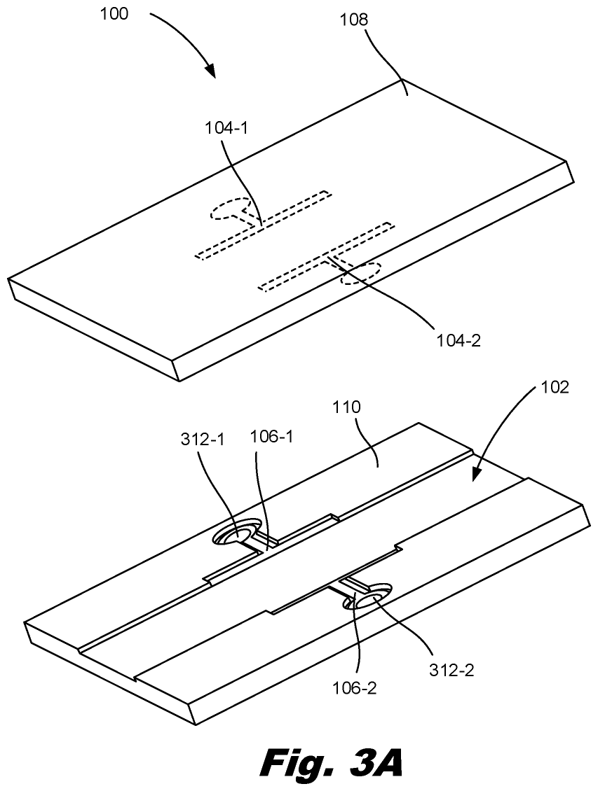

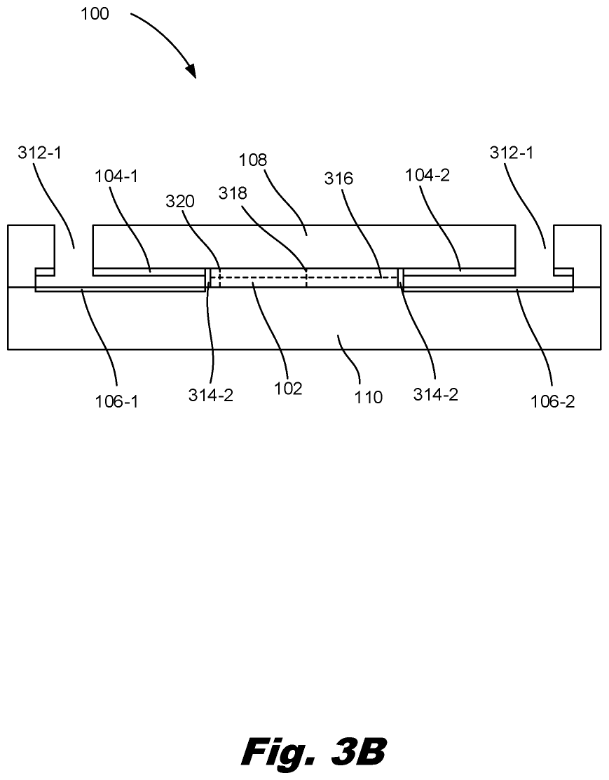

FIGS. 3A and 3B are views of a fluid manipulation system (100) with electrode pairs on either side of a microfluidic channel (102), according to an example of the principles described herein. Specifically, FIG. 3A is an exploded isometric view of the fluid manipulation system (100) and FIG. 3B is a cross-sectional view of the fluid manipulation system (100).

As depicted in FIG. 3A and as described above, the top electrodes (104-1, 104-2) may be formed in a lid layer (108), which lid layer (108) may be formed of a material such as plastic or glass and may be transparent to provide visibility into operations occurring within the microfluidic channel (102). In FIG. 3A, the top electrodes (104-1, 104-2) are depicted in dashed lines to indicate their position on an underside of the lid layer (108).

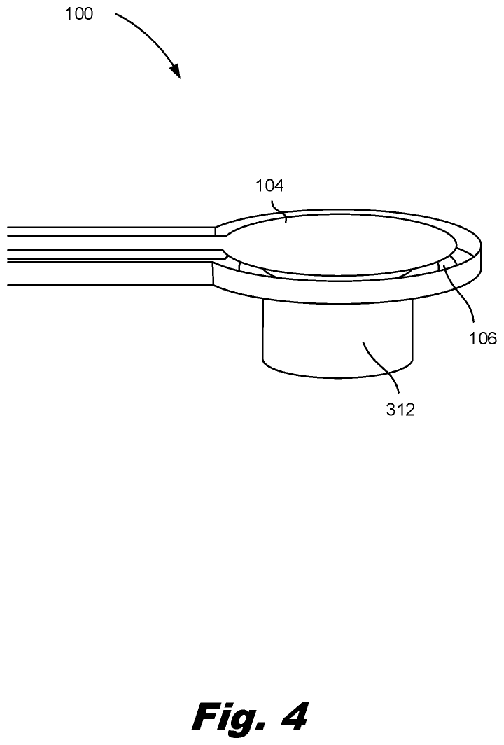

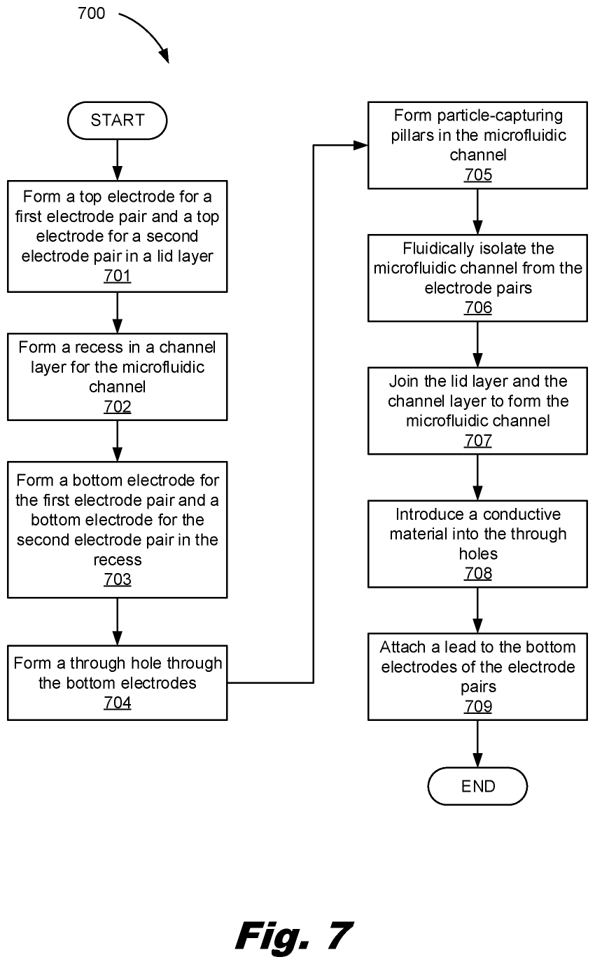

FIG. 3A also depicts the channel layer (110) with the components formed therein. As depicted in FIG. 3A, the microfluidic channel (102) and bottom electrodes (106-1, 106-2) may be formed in a recess of the channel layer (110). As such, when the lid layer (108) and the channel layer (110) are joined, the microfluidic channel (102) is formed in one region and a gap is formed between the top electrodes (104) and the bottom electrodes (106) respectively. This gap may be filled with a conductive material as described below in connection with FIGS. 4 and 7.

In an example, the fluid manipulation system (100) further includes a through hole (312-1) formed through the bottom electrode (106-1) of the first electrode pair and a through hole (312-2) formed through the bottom electrode (106-2) of the second electrode pair. The through holes (312) provide access to the top electrodes (104). That is, once formed, the top electrode (104) may be sandwiched between the lid layer (108) and the channel layer (110). Accordingly, access to the top electrode (104) may be provided via the through holes (312). Such access may be for a number of reasons. For example, it may be desirable to introduce a conductive paste between respective top and bottom electrodes so as to facilitate electrical connection therebetween. It may also be desirable to couple the top and bottom electrodes to a lead connected to a controller which passes signals to the electrodes (104, 106) to generate the alternating current field. As such, the through holes (312) provide the access for these and other operations.

In this example, the bottom electrode (106-1) of the first electrode pair and the bottom electrode (106-2) of the second electrode pair are ring electrodes around a respective through hole.

FIG. 3B clearly depicts those components previously described. In the example depicted in FIG. 3B, the fluid manipulation system (100) includes additional components. For example, the fluid manipulation system (100) may include barriers (314-1, 314-2) between each of the first electrode pair and the second electrode pair and the microfluidic channel (102). The barrier (314) may prevent contact of the electrodes (104, 106) with any solution being analyzed in the microfluidic channel (102). For example, it may be desirable for the microfluidic channel (102), and any particle-capturing array therein, to be separated from the electrodes (104, 106). As such, the present fluid manipulation system (100) with a barrier (314) may reduce the flow towards the electrodes (104, 106). Doing so may reduce the impact of extraction chemistry and may avoid losing a quantity of the particles into the electrode (104, 106) region.

In addition to preventing the electrodes (104, 106) and content of the microfluidic channel (102) from contacting one another, the barriers (314) may also prevent conductive material from flowing into the microfluidic channel (102). That is, as described above, a conductive paste may be introduced into the through holes (312) to electrically couple the top and bottom electrodes. In some examples, the conductive material may be viscous and as such may not be able to flow into the microfluidic channel (102). However, to ensure that such flow does not occur, a barrier (314) may be introduced which may allow ions to flow, but may block other components such as the sample fluid and/or the conductive paste.

Such a barrier (314) may take many forms. For example, the barrier (314) may be a porous silicon membrane that allows ions to pass, but may block other components. In another example, the barrier (314) may be a region of reduced cross section or an overflow reservoir to capture the conductive paste or other component.

As described above, the fluid manipulation system (100) of the present specification may provide enhanced electrical field parameters. A test was done to evaluate the electrical field of the electrode pair arrangement as compared to vertical wall electrodes, which may be referred to as 3D electrodes, and a planar electrode arrangement where a single electrode is positioned on either side of the microfluidic channel (102). The results of which are now presented. That is, the vertical wall electrodes, which are complex and difficult to practically implement, provide a baseline for a comparison of the performance of the planar electrodes with the electrode pairs of the present specification.

TABLE (1)

| Model Type | 3D Electrodes | Planar Electrodes | Electrode Pairs |
|---|---|---|---|
| Average electric | 2472.7 | 2048.1 | 2383.4 |
| field (V/m) | | | |
| % Reduction from | 0% | 17.2% | 3.6% |
| 3D electrodes | | | |

As depicted in Table (1), the average electrical field across a microfluidic channel (102) with spaced electrode pairs was closer to that of an ideal 3D model than a planar electrode configuration.

Table (2) depicts the average electrical field along a microfluidic channel (102) width through the middle of the microfluidic channel (102) as indicated by the line (316).

TABLE (2)

| Model Type | 3D Electrodes | Planar Electrodes | Electrode Pairs |
|---|---|---|---|
| Average electric | 3120.5 | 2746.6 | 3059.4 |
| field (V/m) | | | |
| % Reduction from | 0% | 12.0% | 2.0% |
| 3D electrodes | | | |

As depicted in Table (2), the average electrical field across the width of the microfluidic channel (102) with spaced electrode pairs was closer to that of an ideal 3D model than a planar electrode configuration.

Table (3) depicts the average electrical field along the microfluidic channel (102) through the height of the microfluidic channel (102) at the center of the microfluidic channel (102). indicated by the line (318).

TABLE (3)

| Model Type | 3D Electrodes | Planar Electrodes | Electrode Pairs |
|---|---|---|---|
| Average electric | 3099.3 | 2542.9 | 3009.5 |
| field (V/m) | | | |
| % Reduction from | 0% | 18.0% | 2.9% |
| 3D electrodes | | | |

As depicted in Table (3), the average electrical field across the height of the microfluidic channel (102) at the center of the microfluidic channel (102) was closer to that of an ideal 3D model than a planar electrode configuration.

Table (4) depicts the average electrical field along the microfluidic channel (102) through the height of the microfluidic channel (102) at an edge of the microfluidic channel (102). indicated by the line (320).

TABLE (4)

| Model Type | 3D Electrodes | Planar Electrodes | Electrode Pairs |
|---|---|---|---|
| Average electric | 3162.5 | 3587.7 | 3539.3 |
| field (V/m) | | | |
| % Reduction from | 0% | 13.9% | 11.9% |
| 3D electrodes | | | |

As depicted in Table (4), the average electrical field across the height of the microfluidic channel (102) at the edge of the microfluidic channel (102) was closer to that of an ideal 3D model than a planar electrode configuration.

FIG. 4 is a view of a through hole (312) on either side of a microfluidic channel (FIG. 1, 102), according to an example of the principles described herein. As described above, as the bottom electrode (106) is formed in a recess of the channel layer (FIG. 1, 110), there is a gap formed between the bottom electrode (106) and the top electrode (104). This gap may be filled with a conductive material to link the top and bottom electrodes and give easy access for electrode leads. In some examples, the conductive material may be a metallic paste, such as silver paste.

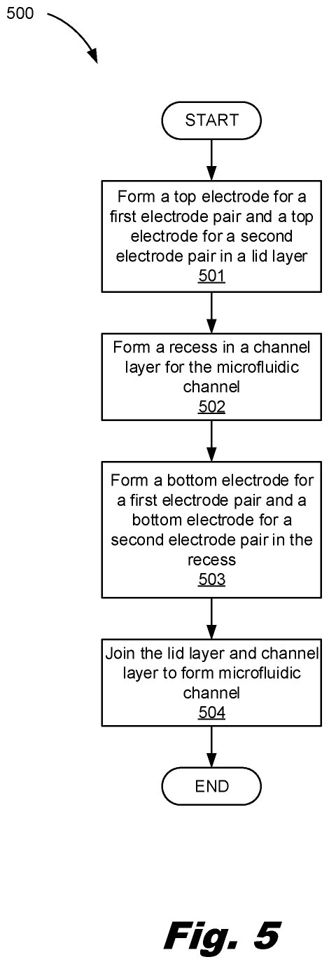

FIG. 5 is a flowchart of a method (500) for forming a fluid manipulation system (FIG. 1, 100) with electrode pairs on either side of a microfluidic channel (FIG. 1, 102), according to an example of the principles described herein. According to the method (500), a top electrode (FIG. 1, 104-1) for a first electrode pair and a top electrode (FIG. 1, 104-2) for the second electrode pair are formed (block 501) in a lid layer (FIG. 1, 108), which lid layer (FIG. 1, 108) forms a part of the microfluidic channel (FIG. 1, 102). Formation (block 501) of the top electrodes (FIG. 1, 104) may include thin film deposition operations including sputtering and etching. For example, the top electrodes (FIG. 1, 104) may be sputtered through a proximity mask. In another example, the top electrodes (FIG. 1, 104) may be deposited in blanket form and then photomasked and etched. In this example, adhesion may be implemented to form (block 501) the top electrodes (FIG. 1, 104).

As described above, the lid layer (FIG. 1, 108) may be formed of a transparent material such as glass or plastic. As such, forming (block 501) the top electrodes (FIG. 1, 104) may include depositing a conductive material on the glass substrate.

As described above, the floor of the microfluidic channel (FIG. 1, 102) and walls of the microfluidic channel (FIG. 1, 102) may be formed in a channel layer (FIG. 1, 110) substrate such as glass, plastic, or silicon. Accordingly, the recess may be formed (block 502) in the channel layer (FIG. 1, 110). In addition to defining the microfluidic channel (FIG. 1, 102), the recess may provide the gap between the top electrodes (FIG. 1, 104) and the bottom electrodes (FIG. 1, 106) which are formed in the channel layer (FIG. 1, 110) as well. That is, the recess may define the microfluidic channel (FIG. 1, 102) and may retain bottom electrodes (FIG. 1, 106) for the first electrode pair and the second electrode pair while providing a gap between bottom electrodes (FIG. 1, 106) and top electrodes (FIG. 1, 104). Such formation (block 502) of the recess may be based on the substrate material. For example, a deep reactive-ion etching (DRIE) operation may be used to form (block 502) the recess when the substrate is silicon. As another example, when the channel layer (FIG. 1, 110) is a polymer such as SU-8, the recesses may be formed (block 502) as a liquid or dry film in multiple steps of exposure and development to generate the recessed floor. As yet another example, a polymer-based channel layer (FIG. 1, 110) may be formed via injection molding.

The bottom electrodes (FIG. 1, 106) may be formed (block 503) for the first electrode pair and the second electrode pair in regions of the recess that are adjacent a region of the recess which is to define the microfluidic channel (FIG. 1, 102). That is, as depicted in FIGS. 2, 3A, and 3B, the electrodes (FIG. 1, 104, 106) may be adjacent sidewalls of the microfluidic channel (FIG. 1, 102). Accordingly, the bottom electrodes (FIG. 1, 106) may be formed along these sidewalls. As with the top electrodes (FIG. 1, 104), the bottom electrodes (FIG. 1, 106) may be formed (block 503) via sputtering, etching, photomasking, or any other operation.

With electrodes (FIG. 1, 104, 106) defined in respective layers, the lid layer (FIG. 1, 108) and the channel layer (FIG. 1, 110) may be joined (block 504) to define the microfluidic channel (FIG. 1, 102). As the lid layer (FIG. 1, 108) includes a top electrode (FIG. 1, 104) and the channel layer (FIG. 1, 110) includes a bottom electrode (FIG. 1, 106), the joining (block 504) of these two layers forms the electrode pair with a gap therebetween.

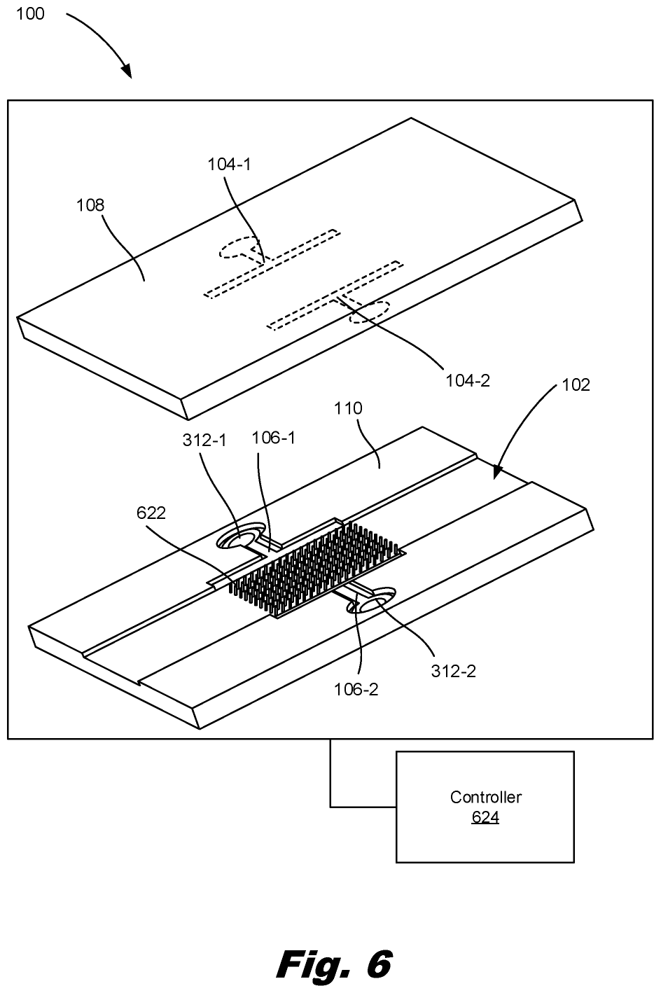

FIG. 6 is an isometric view of a fluid manipulation system (100) with electrode pairs on either side of a microfluidic channel (102), according to an example of the principles described herein. As described above, the fluid manipulation system (100) includes a microfluidic channel (102). The fluid manipulation system (100) also includes a first electrode pair that is along a first sidewall of the microfluidic channel (102) and that includes a top electrode (104-1) and a bottom electrode (106-1) with a gap therebetween. The fluid manipulation system (100) also includes a second electrode pair that is along a second sidewall of the microfluidic channel (102) and that includes a top electrode (104-2) and a bottom electrode (106-2) with a gap therebetween.

FIG. 6 depicts an example with additional components. For example, to capture the DNA strands or other particles of interest, the fluid manipulation system (100) may include an array (622) of particle-capturing pillars disposed within the microfluidic channel (102).

In one particular example, the particle-capturing pillars may be used in solid phase extraction (SPE). SPE may target various biomolecules such as DNA for extraction and isolation. As a specific example, nucleic acid testing may use a genomic target which is one of many markers to specifically identify pathogens. In this example, SPE may include five stages: cell lysis, sample preparation, nucleic acid absorption, washing, and elution. Cellular components such as membranes that surround and protect the DNA are first lysed or breached to allow for the DNA extraction to occur. The released double-stranded DNA (dsDNA) is then separated from the other debris and exposed dsDNA is mixed with a solid phase or sorbent for extraction. In some examples, the sorbent mix may be conditioned with a buffer to prepare the functional groups on the sorbent matrix to bind to the phosphate backbone of DNA.

Separating the dsDNA from the other debris may be carried out by the fluid manipulation system (100). As such, the fluid is moved past the particle-capturing pillars, and the particles are adsorbed onto the particle-capturing pillars. As described above, the particle-capturing pillars may be functionalized for either specific or non-specific binding for analytes such as DNA or RNA. In one example, surface functionalization may be accomplished by using a material such as silica to fabricate the pillars.

In some examples, the particle-capturing pillars are silica pillars that provide additional surface area to interact with and ultimately capture the DNA. The particle-capturing pillars, given the appropriate fluid chemistry and reagents, may be coated with a chaotropic agent and/or obstacles to mediate/enhance the particle-to-surface interaction. While silica is referenced as one pillar surface feature to capture biomolecules, other compounds may be used to mediate/enhance the capturing capability of the pillars. Examples include chitosan and amino acids.

In another example, a magnetic material of the pillars may be used to tether beads to the pillars. These beads may increase the capture rate of the particles from the fluid. In some examples, the beads may be formed of a para-magnetic material such as polystyrene or iron oxide and may have a size between 1 and 10 microns.

In some examples, the beads themselves may be magnetic or paramagnetic. Magnetic bead-based SPE offers a platform to manipulate DNA absorption and desorption while being easily scalable and reproducible. In one example, micron-sized paramagnetic beads coated with a silica sorbent matrix may be utilized to bind to the DNA. These paramagnetic beads exhibit non-magnetic behavior unless exposed to an external magnetic field. Doing so allows the beads to become immobilized under the presence of a magnetic field for separation processes, removing the need for repeated centrifugation or spin column separation. Implementing surface-functionalized magnetic beads in microfluidic systems allows for a high surface-to-volume ratio for optimal binding efficiency.

As described above, either the beads or the pillars themselves may be functionalized to attract particles passing by. Such functionalization may be based on specific or non-specific binding of a target particle. An example of a specific binding surface is a reverse primer, which would be a complement to a target nucleic acid sequence and capture the target nucleic acids. An example of a non-specific binding surface is streptavidin which may be used to isolate biotinylated targets including oligomers and antibodies. Such a non-specific binding surface may be sticky to biologic substances.

The use of beads and pillars together may allow for customized assays based on a more universal microfluidic device. That is, a base microfluidic device with wide application may be implemented and a target particle may be targeted via functionalized beads. In addition, functionalization of the beads and pillars can be optimized for bead aggregation together with specific or non-specific binding of target analyte in conjunction with reagent chemistry that may be adjusted to elute the from surfaces, e.g., through the use of salts, pH changes, or surfactants.

The use of beads may decrease the distance between adjacent pillars such that more particles are captured. The beads may also disrupt the flow paths between the pillars so as to increase particle capture rates. Once a sample has been transported through the microfluidic channel (102), the extracted particles may be captured from the pillars for subsequent analysis.

Note that while in FIG. 6 the particle-capturing pillars are depicted as having a particular shape and size, the particle-capturing pillars may be formed to have any cross-sectional shape and size. For example, the particle-capturing pillars may have a round, triangular, rectangular, ovular, rhomboidal, elliptical, hexagonal or diamond cross-section. The cross-sectional shape and dimensions of the particle-capturing pillars may be selected based on the characteristics of the particles to be captured and the fluid in which the particles is dispersed. Note also that while FIG. 6 depicts a particular configuration and spacing of the particle-capturing pillars a variety of spacings may be used. The spacing, size, and shape of the particle-capturing pillars may be determined based on the particles to be captured and other characteristics.

FIG. 6 also depicts the controller (624) which manages the generation of the electrical field. The controller (624) may send a signal to the electrodes (104, 106) which selectively activates/deactivates the electrodes (104, 106) to generate the alternating current signal. Specifically, different particles may have different charges such that different particles may interact with electrical fields in different ways. As a particular example, a higher voltage and/or frequency may be implemented to move certain cells where a lower voltage and/or frequency may be sufficient to move other types of cells. This may be due to the charge of those particles and/or the weight of those particles. Moreover, as described above, based on the geometry of the microfluidic channel (102) and the particle-capturing pillar size, shape, and spacing, a stronger or weaker electrical force may be used to move particles the desired distance. That is, the distance that a particle moves in the transverse direction may be equal to or greater than the particle-capturing pillar spacing to ensure that each particle may be in contact with at least one particle-capturing pillar.

As such, the controller (624) may determine, based on a weight and an electrical charge of particles to be captured, alternating current electrical fields to move the particles a distance at least as great as a spacing between particle-capturing pillars and applies voltages to generate the alternating electrical fields. That is, flow rates and AC field frequency should allow target biomolecules to pass, at least once, near particle-capturing pillars. Accordingly, the biomolecule motion amplitude may at least equal a spacing between particle-capturing pillars. In some examples, this may be based off empirical and historically collected data found in a database. In another example, the force to be applied may be calculated.

The controller (624) may include various hardware components, which may include a processor and memory. The processor may include the hardware architecture to retrieve executable code from the memory and execute the executable code. As specific examples, the controller as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the controller (624) cause the controller (624) to implement at least the functionality of applying AC voltages to the electrodes (104, 106).

As demonstrated above, the electrical field generated by electrode pairs on either side of the microfluidic channel (FIG. 1, 102) may increase the efficiency of the generated field. Similar to those tests described above in connection with FIG. 3B, additional tests were evaluated to determine the electrical field as a function of microfluidic channel (102) height in a microfluidic channel (102) having an array (622) of particle-capturing pillars. When evaluated near an edge of the microfluidic channel (102) near the electrodes (104, 106), the electrode pair configuration exhibited less variation of electrical field across a height of the microfluidic channel as compared to a planar electrode configuration.

When evaluated a quarter of the way towards the center of the microfluidic channel (102), the electric field in the electrode pair configuration had less decay across the height of the microfluidic channel (102) and an overall greater magnitude than the planar electrode configuration

When evaluated at the center of the microfluidic channel (102), the electric field in the electrode pair configuration had an overall greater magnitude than the planar electrode configuration.

When measured across a width of the microfluidic channel (102) adjacent a top of the microfluidic channel (102), the electric field in the electrode pair configuration with an array (622) of particle-capturing pillars exhibited a more consistent electrical field at a greater magnitude. When measured across a width of the microfluidic channel (102) across a median of the microfluidic channel (102), the electric field in the electrode pair configuration with an array (622) of particle-capturing pillars also exhibited an electrical field at a greater magnitude.

FIG. 7 is a flowchart of a method (700) for forming a fluid manipulation system (FIG. 1, 100) with electrode pairs on either side of a microfluidic channel (FIG. 1, 102), according to an example of the principles described herein. In an example, the method (700) includes forming (block 701) top electrodes (FIG. 1, 104) for both the first electrode pair and the second electrode pair in a lid layer (FIG. 1, 108). A recess may be formed (block 702) and a bottom electrode (FIG. 1, 104) formed (block 703) in the channel layer (FIG. 1, 110). These operations may be performed as described above in connection with FIG. 5.

In an example, through holes (FIG. 3, 312) may be formed (block 704) through the bottom electrodes (FIG. 1, 104) of the first electrode pair and the second electrode pair. The formation (block 704) may include etching or drilling through the channel layer (FIG. 1, 110). As a specific example, a silicon channel layer (FIG. 1, 110) may be wet-etched in tetramethylammonium hydroxide (TMAH) or potassium hydroxide (KOH). In another example, a glass channel layer (FIG. 1, 110) may be etched in hydrofluoric or nitric acid. As yet another example, the through holes may be formed (block 704) by laser drilling through the channel layer (FIG. 1, 110). As described above, such through holes (FIG. 3, 312) may facilitate conductive paste insertion and coupling of the electrodes (FIG. 1, 104, 106) to leads.

The method (700) may also include forming (block 705) particle-capturing pillars within the microfluidic channel (FIG. 1, 102). Formation (block 705) of such pillars may include etching the channel layer (FIG. 1, 110) to define the pillars. That is, the channel layer (FIG. 1, 110) may be etched to define the recess that defines the microfluidic channel (FIG. 1, 102) as well as the array (FIG. 6, 622) of particle-capturing pillars. In this example, an etching process such as DRIE through a photolithographic mask may be used to define the particle-capturing pillars.

In another example, the pillars may be additively formed through a process such as epitaxial deposition. In either example, the surface of the particle-capturing pillars may be activated with a particle-attracting material.

In an example, the microfluidic channel (FIG. 1, 102) may be separated from the electrodes (FIG. 1, 104, 106). Accordingly, in this example the method (700) may include fluidically isolating (block 706) the microfluidic channel (FIG. 1, 102) from the electrode pairs. This may include forming the barrier (FIG. 3, 314) in whatever form. As described above, this may include depositing or sputtering a silicon wall and/or may include defining the recess to have a vertical wall or reduce cross-section area between the electrodes (FIG. 1, 104, 106) and the microfluidic channel (FIG. 1, 102). As another example, the barrier (FIG. 3, 314) may be formed of an agarose gel which is able to pass ions, but not fluids. As yet another example, the barrier (FIG. 3, 314) may be a membrane that enables electroosmotic conduction while preventing fluid transport.

With these components formed, the lid layer (FIG. 1, 108) may be joined (block 707) to the channel layer (FIG. 1, 110) as described above in connection with FIG. 5 to define the microfluidic channel (FIG. 1, 102). This may be performed as described above in connection with FIG. 5.

As described above, the through holes (FIG. 3, 312) may serve a variety of purposes, including allowing for introduction of a conductive paste to electrically couple bottom electrodes (FIG. 1, 106) with respective top electrodes (FIG. 1, 104). Accordingly, the conductive material may be introduced (block 708) into the through holes (FIG. 3, 312) to electrically couple these components. As described above, in an example, the conductive material may be a conductive silver paste.

Also as described above, a lead may be attached (block 709) to the bottom electrode (FIG. 1, 104) of the electrode pairs. The lead may be introduced via the through holes (FIG. 3, 312).

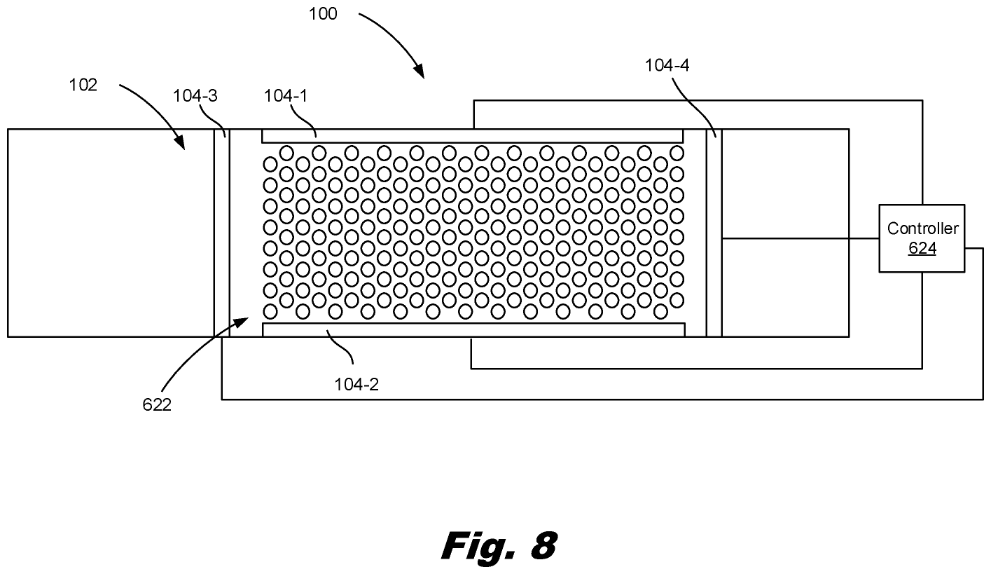

FIG. 8 is a top view of a fluid manipulation system (100) with electrode pairs on either side of a microfluidic channel (102), according to an example of the principles described herein. FIG. 8 clearly depicts the array (622) of particle-capturing pillars as well as the top electrodes (104-1, 104-2) on the sidewalls. As FIG. 8 is a top view, the bottom electrodes (FIG. 1, 106-1, 106-2) are not visible as they are disposed underneath the top electrodes (104-1, 104-2). In the example depicted in FIG. 8, the fluid manipulation system (100) includes additional electrode pairs. For example, the fluid manipulation system (100) may include a third electrode pair on a third side of the microfluidic channel (102), which third electrode pair includes a top electrode (104-3) and a bottom electrode (not visible, but underneath the third pair top electrode (104-3)).

In this example, the fluid manipulation system (100) may include a fourth electrode pair on a fourth side of the microfluidic channel (102), which fourth electrode pair includes a top electrode (104-4) and a bottom electrode (not visible, but underneath the fourth pair top electrode (104-4)). In this example as depicted in FIG. 8, the first side and second side, which the first pair and second pair respectively are disposed against, are parallel to flow of the fluid through the microfluidic channel (102) while the third side and the fourth side, which the third pair and the fourth pair respectively are disposed against, are perpendicular to the flow of the fluid through the microfluidic channel (102). Such an arrangement may further manipulate the fluid as it passes through the microfluidic channel (102).

For example, the third electrode pair and the fourth electrode pair may be used to cause separation in the microfluidic channel (102). A specific example may be alternating current (AC) dielectrophoresis (DEP). In AC DEP, interdigitated electrode pairs may span a width of the microfluidic channel (102). The third electrode pair and the fourth electrode pair in FIG. 8 are arranged to span the width of the microfluidic channel (102). These electrode pairs may be driven to either trap, levitate, or deflect the particles, such as nucleic acids or cells, within the microfluidic channel (102). That is, in this example, pairs of electrode pairs may span the width of the microfluidic channel (102) at predetermined points to form “separation chambers” where the electrode pairs that are perpendicular to fluid flow may be used to stop fluid flow, i.e., retain the fluid in the array region of the microfluidic channel (102), while a particular operation is carried out. These same perpendicularly-oriented electrode pairs may later be activated to move the fluid out of the array region, i.e., the separation chamber, into another region.

As such, the perpendicularly-orientated electrode pairs may retain fluid in a region where mixing and trapping occur and as such increase mixing and capture rates as fluid is retained in a capture zone for a longer period of time. For example, as DNA enters into an array region of the microfluidic channel (102), the controller (624) may activate the third and fourth electrode pairs to slow down the DNA/target sample while other portions of the fluid pass by, thus increasing the suspension, mixing, and reactions that occur.

These perpendicularly-oriented electrode pairs may also facilitate particle detection. That is, the perpendicularly-oriented electrode pairs, i.e., the third and fourth electrode pairs in FIG. 8 may detect species passing through and moving along with the flow.

While FIG. 8 depicts the third and fourth electrode pairs as linear electrodes, these electrode pairs may be patterned as chevrons spanning the width of the microfluidic channel (102) to effect separations via deflection without trapping.

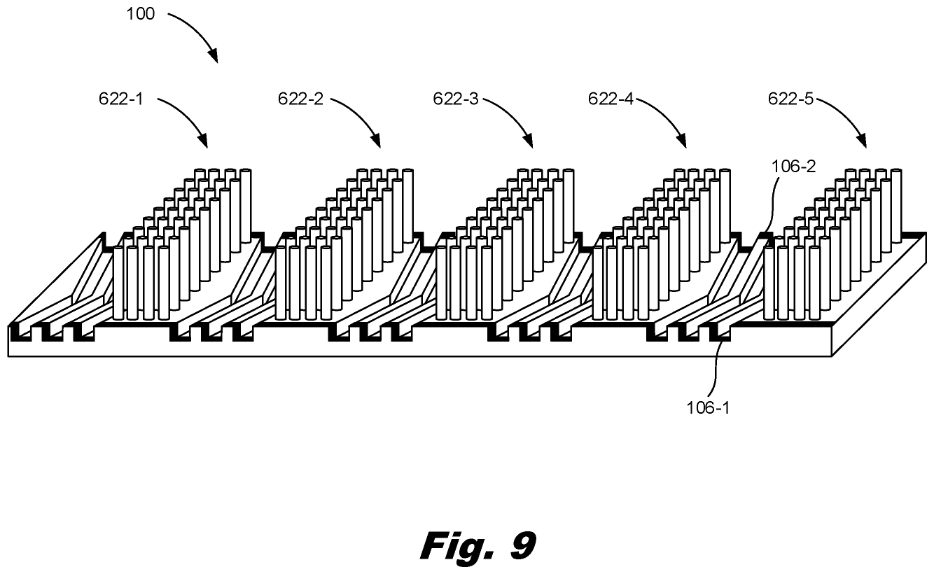

FIG. 9 is a diagram of a fluid manipulation system (100) with electrode pairs on either side of a microfluidic channel (FIG. 1, 102), according to examples of the principles described herein. As depicted in FIG. 9, the microfluidic channel (FIG. 1, 102) may be defined by regions that include arrays (622-1, 622-2, 622-3, 622-4, 622-5) separated by non-array regions. In this example, the bottom electrodes (106-1, 106-2) may follow the contour of the microfluidic channel (FIG. 1, 102). This contoured portion of the bottom electrodes (106) may lead to a ring-based portion of the bottom electrodes (FIG. 1, 106) with a corresponding through hole (FIG. 3, 312). That is, while the electrode may have some morphology, it may still include the round interconnect depicted in FIGS. 2-4.

In the example depicted in FIG. 9, regions of the microfluidic channel (FIG. 1, 102) that include particle-capturing pillars are separated by regions where a floor of the microfluidic channel (FIG. 1, 102) includes chevron recesses. As fluid passes through the microfluidic channel (FIG. 1, 102), it enters the recesses which impede laminar flow and introduce vortices and chaotic mixing such that the particles in the fluid reside in the microfluidic channel (FIG. 1, 102) for a longer period of time and thus have greater opportunity to interact with the particle-capturing pillars. Moreover, the fluid may be mixed and/or disturbed before entering a particle-capturing array (622) of the microfluidic channel (FIG. 1, 102). Such a mixing promotes a more uniform distribution of the particles throughout the liquid carrier such that particles are uniformly captured across a width of the microfluidic channel (FIG. 1, 102).

Note that in some examples, the particle-capturing pillars within a single array (622) may have similar features, i.e., similar cross-sectional shape and size and a similar height. However, particle-capturing pillars in different arrays (622) may be differently shaped and/or sized. Accordingly, the different arrays (622) may filter and/or separate different particles from the solution. Along these lines, the recesses between different arrays (622) may be different.

Moreover, by interspersing recesses regions with particle-capturing pillars, a constant and continuous mixing of the fluid and particles results. Doing so may yield even greater particle capture as the particles are homogenously mixed, not at rest, and do not settle.

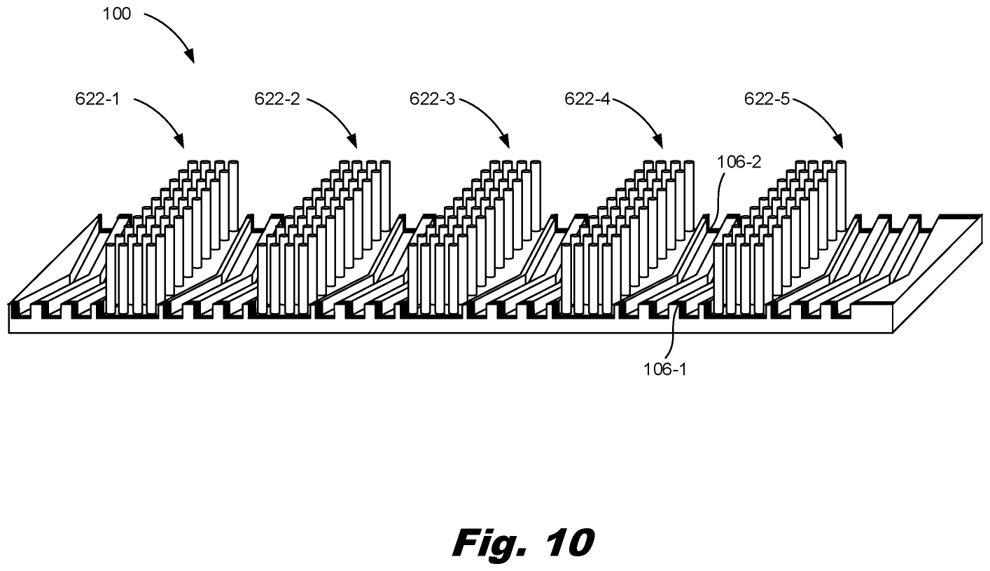

FIG. 10 is a diagram of a fluid manipulation system (100) with electrode pairs on either side of a microfluidic channel (FIG. 1, 102), according to examples of the principles described herein. In the example depicted in FIG. 10, the particle-capturing pillars are formed in trenches in the floor of the microfluidic channel (FIG. 1, 102). Doing so may further increase the amount and strength of vortices to increase the rate of mixing and/or separation.

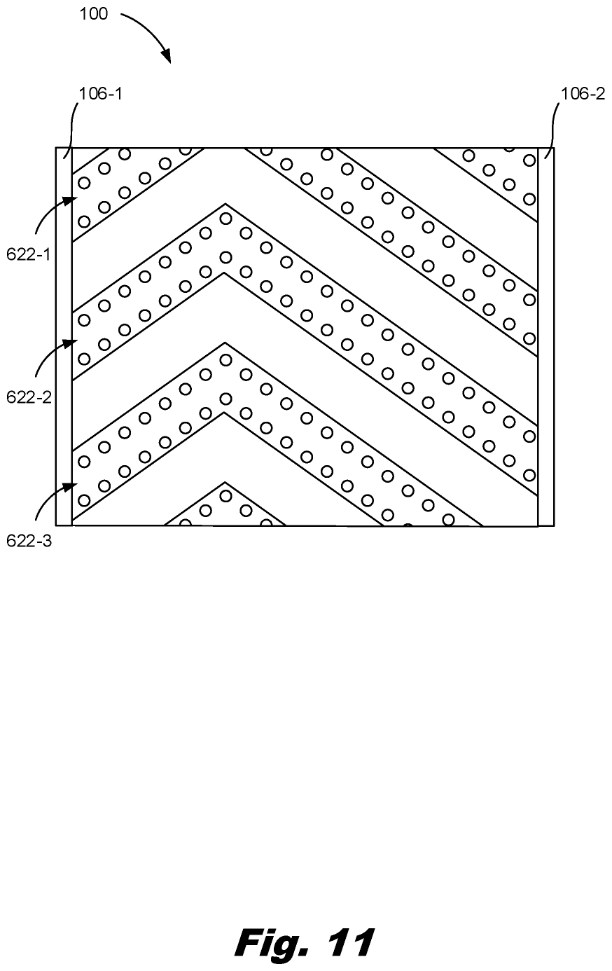

FIG. 11 is a top view of a fluid manipulation system (100) with electrode pairs on either side of a microfluidic channel (FIG. 1, 102), according to an example of the principles described herein. In the example depicted in FIG. 11, the regions of the microfluidic channel (FIG. 1, 102) on which the arrays (622) are disposed are chevron-shaped, much like the trenches described above in connection with FIGS. 9 and 10. Doing so may increase the amount of chaotic mixing and separation.

In summary, using such a fluid manipulation system 1) provides efficient particle separation from a liquid carrier; 2) may reduce the size of the fluid manipulation system by capturing more particle in a smaller distance; 3) increases particle time in a particle-capturing region; 4) generates a more uniform electrical field for particle capture; 5) induces transverse flow of particles to increase mixing and probability for particle capture; 6) provides large surface area for capturing particles; 7) is a simple structure to integrate on a chip; 8) provides low fluidic resistance; and 9) is low cost. However, the devices disclosed herein may address other matters and deficiencies in a number of technical areas.

What is claimed is:

1. A fluid manipulation system, comprising:
a microfluidic channel through which fluid is to flow, wherein the fluid comprises particles to be separated;
a first electrode pair on a first side of the microfluidic channel, the first electrode pair comprising a top electrode formed on a lid of the microfluidic channel and a bottom electrode formed on a floor of the microfluidic channel; and
a second electrode pair on a second side of the microfluidic channel, the second electrode pair comprising a top electrode and a bottom electrode,
wherein the electrode pairs are to generate an alternating electrical field across the microfluidic channel.

2. The fluid manipulation system of claim 1:
further comprising:
a through hole formed through the bottom electrode of the first electrode pair; and
a through hole formed through the bottom electrode of the second electrode pair; and
wherein the bottom electrode of the first electrode pair and the bottom electrode of the second electrode pair comprise a ring electrode around a respective through hole.

3. The fluid manipulation system of claim 1, further comprising:
a third electrode pair on a third side of the microfluidic channel, the third electrode pair comprising a top electrode and a bottom electrode; and
a fourth electrode pair on a fourth side of the microfluidic channel, the fourth electrode pair comprising a top electrode and a bottom electrode.

4. The fluid manipulation system of claim 3, wherein:
the first side and the second side are parallel to the flow of the fluid through the microfluidic channel; and
the third side and the fourth side are perpendicular to the flow of the fluid through the microfluidic channel.

5. The fluid manipulation system of claim 1, further comprising an array of particle-capturing pillars disposed within the microfluidic channel.

6. The fluid manipulation system of claim 5, wherein:
regions of the microfluidic channel comprising particle-capturing pillars are separated by regions where a floor of the microfluidic channel comprises chevron recesses.

7. The fluid manipulation system of claim 6, wherein the particle-capturing pillars are formed in trenches in the floor of the microfluidic channel.

8. A method, comprising:
forming a top electrode for a first electrode pair and a top electrode for a second electrode pair in a lid layer of a microfluidic channel;
forming a recess in a channel layer, the recess to define the microfluidic channel and to retain bottom electrodes for the first electrode pair and the second electrode pair;
forming a bottom electrode for the first electrode pair and a bottom electrode for the second electrode layer in regions of the recess adjacent a region of the recess which is to define the microfluidic channel; and
joining the lid layer and the channel layer to form a microfluidic channel with electrode pairs on either side with a gap between respective top and bottom electrodes.

9. The method of claim 8, further comprising forming particle-capturing pillars within the microfluidic channel.

10. The method of claim 8, further comprising:
forming a through hole through the bottom electrode of the first electrode pair; and
forming a through hole through the bottom electrode of the second electrode pair.

11. The method of claim 10, further comprising introducing a conductive material into the through holes to electrically couple the top electrode and bottom electrode of respective electrode pairs.

12. The method of claim 10, further comprising attaching a lead to the bottom electrodes of the electrode pairs via the through holes.

13. The method of claim 8, further comprising fluidically isolating the microfluidic channel from the electrode pairs.

14. A fluid manipulation system, comprising:
a microfluidic channel through which fluid is to flow, wherein the fluid comprises particles to be separated;
an array of particle-capturing pillars disposed within the microfluidic channel to capture particles from the fluid;
a first electrode pair along a first sidewall of the microfluidic channel, the first electrode pair comprising a top electrode and a bottom electrode with a gap therebetween; and
a second electrode pair along a second sidewall of the microfluidic channel, the second electrode pair comprising a top electrode and a bottom electrode with a gap therebetween;
wherein the electrode pairs are to generate periodic alternating electrical fields of different values across the microfluidic channel to induce wall-to-wall movement of the fluid towards the particle-capturing pillars; and
a controller to:
determine, based on a weight and an electrical charge of particles to be captured, alternating electrical fields to move the particles a distance at least as great as a spacing between particle-capturing pillars; and
apply voltages to generate the alternating electrical fields.

15. The fluid manipulation system of claim 14, further comprising a barrier between each of the first electrode pair and the second electrode pair and the microfluidic channel.
